(19) United States
(12) Patent Application Publication
(10) Pub. No.: US 2009/0242468 A1
(43) Pub. Date: Oct. 1, 2009

(54) System for Controlling the Concentration of a Detrimental Substance in a Sewer Network

(76) Inventors: Tim Corben, Vijfhuizen (NL); Jürgen Weissenberger, Porsgrunn (NO); Anette Aesoy, Skien (NO)

Correspondence Address: WENDEROTH, LIND & PONACK, L.L.P., 1030 15th Street, N.W.,, Suite 400 East, Washington, DC, 20005-1503, US

(21) Appl. No.: 12/083,635

(22) PCT Filed: Oct. 17, 2005
(86) PCT No.: PCT/NO2005/000388

§ 371 Date: Apr. 16, 2008

(51) Int. Cl. C02F 1/68; C02F 1/00

(52) U.S. Cl. 210/96.1

(57) ABSTRACT

The invention relates to a system for controlling the concentration of a detrimental substance, in particular H₂S, in a sewer network. The system comprises a monitoring device arranged at a monitoring location in the sewer network and at least one dosing controller arranged at a dosing location upstream the monitoring location. The monitoring device is arranged for providing a signal indicating a measured H₂S concentration at the monitoring location and for transmitting a radio frequency signal carrying information about the H₂S concentration. The dosing controller is arranged for receiving the radio frequency signal, deriving a concentration signal based on the radio frequency signal, calculating a dose of a preselected additive based on the derived concentration signal, and supplying a dosing signal to a dosing device, causing the dosing device to add the calculated dose at the dosing location. Advantageously, the calculating of a dose also takes into account critical process indicators acquired at the dosing location. A main controller is arranged to communicate with the at controllers, and various control tasks are distributed among the main controller and the dosing controllers.

### FIELD OF THE INVENTION

The present invention relates generally to monitoring and control of sewer networks.

### BACKGROUND OF THE INVENTION

Sewer networks consist of a large number of pumping stations and manholes with a mix of pumping and gravity mains, and ends up at a treatment plant. Septicity problems caused by hydrogen sulphide formation are generally influenced by water retention time, sewer type/dimensions, water quality like organic matter and phosphorus content, pH, and temperature. Odour problems are the main trigger for treatment, but health effects, high maintenance costs related to corrosion, and negative effects on treatment plants are getting more and more in focus. Odour problems are typically found at manholes and pumping stations in urban areas. Optimal septicity control generally means efficient prevention and removal of hydrogen sulphide where it is needed, in complex sewer networks or in smaller specific sites.

Optimal dosing of chemicals for septicity control in sewer networks requires a system that can take into account dynamic variations in flow, water quality and temperature, the sewer system characteristics, as well as unpredictable scenarios (e.g. rain events, industry effluents). Existing systems for dosing such chemicals are basically simple feed forward systems that are able to give a fairly good dosing control when conditions are relatively stable. However, because of all variations in parameters and the complexity of sewer networks, it is generally quite demanding and difficult to develop optimal dosing algorithms, and they generally need a regular manual optimization based on the monitored results downstream, which typically is H₂S .

Existing technology for dosing control are to a great extent standard computer systems that take into account on-line signals from sewage pumps and various sensor at the point of treatment, and do a feed forward dosing based on system parameters like e.g. sewer dimensions. A challenge in sewer pipelines is the plug flow regime and varying retention time, which means that the optimal dosing at one time depends on the following changes in water flow and quality the next minutes and hours. Therefore, a predictable feed forward system is needed, and this makes it fairly complicated and not always optimized. It could be fairly good in sewers with cyclic, predictable variations, but in most sewers there are many unpredictable variations and irregular flow and water quality patterns that have great impact on the results.

Common H₂S monitoring systems use data loggers that need to be collected for downloading data. This is quite time consuming work and is generally only used in the initial phase of optimization and when documentation is required for further optimization or as general documentation of treatment results. Because of this, many septicity control systems are not always operating at an optimized level. Most H₂S sensors outputs a 4-20 mA signal can be connected to any controller/logger with modem for remote monitoring. Generally, such devices have considerable power consumption, requiring power supply through wires. They are thus less suitable for detached use in manholes, e.g. in a middle of a road.

U.S. Patent Application 2004/0173525 describes a process control system for treating wastewater in a sewer pipeline.

U.S. Patent Application 2004/0239523 describes a wireless remote monitoring system that enables monitoring of measurement instruments from a remote location using the GSM cellular phone network

Japanese patent application JP 2002-054167 A describes a remote monitoring and data logger system for manholes based on the use of cellular phone network

Japanese patent application JP 2003-074081 A describes an apparatus for remote monitoring in manholes with special features to reduce power consumption and increase the lifetime of the batteries.

### SUMMARY OF THE INVENTION

In accordance with the present invention, there is provided a system for controlling the concentration of a detrimental substance in a sewer network as set forth in the independent claim 1.

Advantageous embodiments of the invention are set forth in the dependent claims.

Additional features and principles of the present invention will be recognized from the following description or may be learned by practice of the invention.

### BRIEF DESCRIPTION OF THE DRAWINGS

The accompanying drawings illustrate a preferred embodiment of the invention. The drawings and the detailed description serve to explain the principles, features and aspects of the preferred embodiment of the invention. In the drawings,

FIG. 1 is a schematic block diagram illustrating the principles of a system according to the invention,

FIG. 2 is a schematic block diagram illustrating a system according to the invention in closer detail,

FIG. 3 is an exemplary flow chart illustrating process steps performed by a monitoring device in accordance with the invention, and

FIG. 4 is an exemplary flow chart illustrating process steps performed by a dosing controller in accordance with the invention.

### DETAILED DESCRIPTION OF THE INVENTION

Reference will now be made to the detailed description of the preferred exemplary embodiment of the invention, as illustrated in the drawings. Wherever possible, the same reference numbers will be used throughout the drawings to refer to the same or like parts.

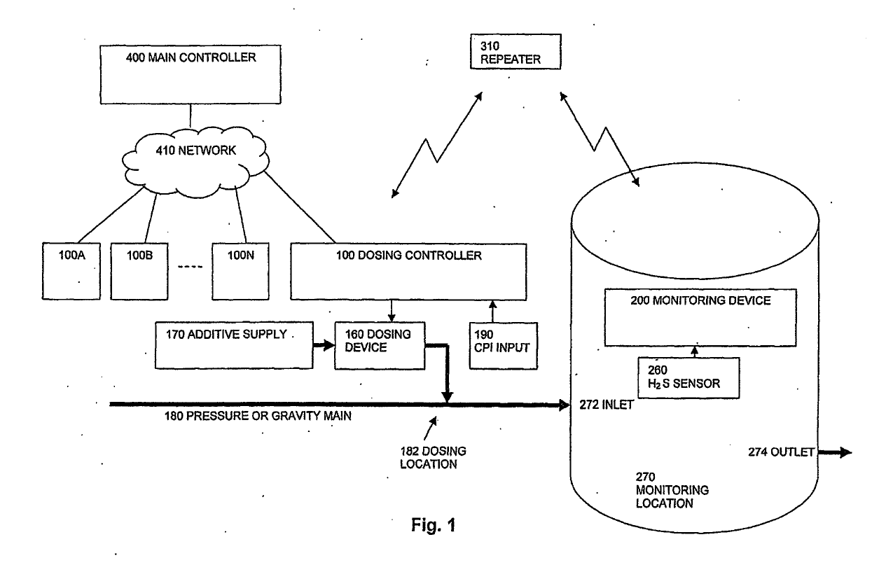

FIG. 1 is a schematic block diagram illustrating the principles of a system according to the invention

An overall purpose of the system is to control the concentration of a detrimental substance at particular locations in a sewer network.

The concentration of the detrimental substance is controlled by adding an additive to the sewer in the sewer network at a dosing-location 182. The dosing of the additive is based on an RF signal received at the dosing location, indicating a concentration of the detrimental substance at a downstream monitoring location 270. The dosing is advantageously also based on measurement signals indicating process variables denoted as critical process indicators (CPIs), acquired at the dosing location 182.

The detrimental substance is generally a smelly and potential dangerous substance, or a mixture of such substances, produced by bacteria in the sewer under the absence of oxygen.

In the preferred embodiment of the invention, the detrimental substance is a reduced organic substance such as a reduced sulphuric compound, in particular H₂S. H₂S often dominates the detrimental substance or mix of substances, and it is therefore used as the preferred parameter for controlling counteractions.

The additive is selected in order to prevent, reduce or remove the detrimental substance in question. Addition of nitrate will suppress bacteria producing H₂S and other reduced compounds and will support bacteria that do not produce detrimental substances. Such microbiological principles are well known in the art. A suitable additive is a pH neutral pure calcium nitrate solution, currently supplied by Yara International ASA under the registered trademark Nutriox®. The right dosage is crucial for the success of this method. Sewage flows varies in time and thus do other parameters influencing the activity of bacteria.

The sewer network is partly illustrated in FIG. 1 by a sewer conduit 180, in particular a pressure or gravity main, or a combination of a pressure and gravity main. The conduit 180 generally leads to a monitoring location 270. In the illustrated example, the monitoring location 270 is a manhole, and the conduit 180 leads to an inlet 272 of the manhole. The outlet of the manhole is indicated at 274.

A H₂S sensor 260 is arranged in the manhole 270 in order to measure the H₂S concentration in the manhole 270.

More specifically, the H₂S sensor 260 comprises an electrochemical sensor cell which provides an electrical signal, preferably an analog voltage signal, whose magnitude is representative of the H₂S gas concentration. Preferably, the sensor 260 provides a standard measurement range of 0 to 200 ppm H₂S in air. Alternatively a sensor cell with a measuring range of 0 to 1000 ppm may be employed. A sensor cell with very low power consumption is preferably used in order to enhance battery lifetime.

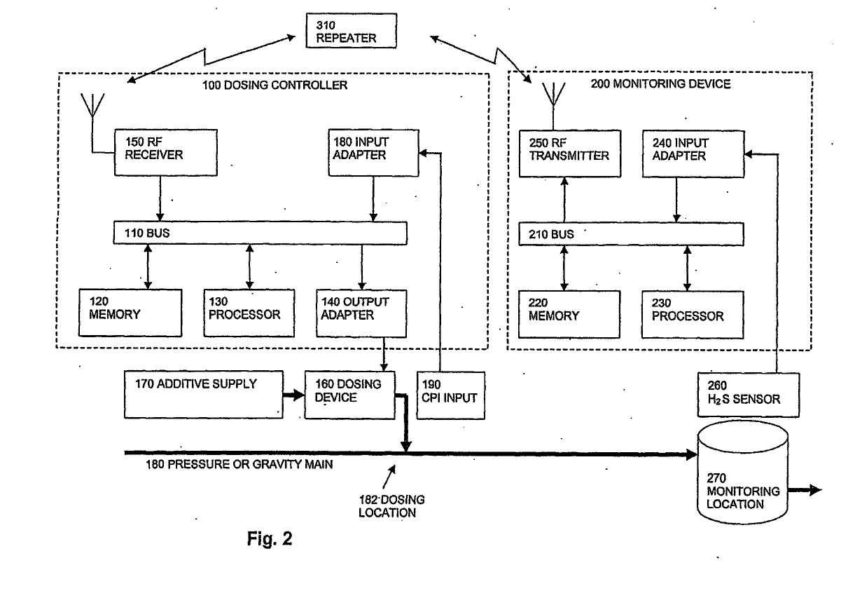

The analog output of the H₂S sensor 260 is connected to a monitoring device 200. The monitoring device 200 is arranged for converting the analog signal into a digital signal indicating the measured H₂S concentration. The monitoring device is further arranged for transmitting a radio frequency signal which carries information representing said concentration signal. The features of the monitoring device is described in closer detail below with reference to FIG. 2.

The monitoring device 200 and the sensor 260 are located in the monitoring location 270, i.e. the manhole. A manhole in a sewer system poses numerous challenges to any device installed in there, including the following:
Humid to wet surroundings
Corrosive gases can be present (mainly H₂S)
Often defined as Explosion zone (EEx zone 1)
No access to power grid
Sub surface
In roads or other public areas
Man hole lid made of cast iron or reinforced concrete
Man hole walls made of reinforced concrete
Some times not easily accessible when in major roads, highways or other heavily used areas.

In order to comply with the above conditions, the sensor 260 and the monitoring device 200 is preferably designed with a single, sturdy housing or encapsulation in order to withstand humidity and corrosive gases. The sensor 260 and the monitoring device 200 are also preferably designed in order to fulfill the requirements of BEx approval. Moreover, the sensor 260 and the monitoring device 200 are preferably battery powered. In particular, the monitoring device 200 should preferably be able to transmit RF signals up to 2.5 km from the subsurface manhole with cast iron/concrete lid.

Further with reference to FIG. 1, the system advantageously comprises an RB repeater 310. The repeater 310 is arranged for receiving the RF signal transmitted by the monitoring device 200, and for transmitting an amplified and/or restored version of the received RB signal. The repeater 310 is arranged above ground between the monitoring device 200 and the dosing controller 100.

Although only one repeater 310 is illustrated, the skilled person will realize that any appropriate numbers of repeaters 310 may be used in the system. Also, if the transmission distance between the monitoring device 200 and the dosing controller 160 is sufficiently short, the RB communication may be established without the use of a repeater 310.

The system farther comprises a dosing controller 100, which is connected to a dosing device 160. The dosing device 160 is arranged for adding a dose of the predetermined additive, supplied from the additive supply 170, at a dosing location 182, along the main 180, upstream the monitoring location 270, i.e. the manhole, in the sewer network.

More specifically, the dosing device 160 comprises a pump which is arranged for receiving an analog or a digital signal from the dosing controller 100 and for supplying a dose of the additive from the additive supply 170 in accordance with the received signal.

The dosing controller 100 is arranged for receiving the RB signal transmitted by the monitoring device 200. Alternatively, if at least one repeater 310 is used, the dosing controller will receive the RF signal transmitted by the repeater 310.

The dosing controller 100 is further arranged for receiving at least one input signal from a group of input signals denoted Critical Process Indicators (CPI). This group of signals comprises at least one of the following signals: a flow measurement signal (e.g. acquired by a flow meter), a temperature measurement signal (e.g. acquired by a temperature sensor), a sewage pump operation signal (acquired by an external sewage pump control system), and a water quality signal (acquired by a water quality sensor at the dosing location 182).

The dosing controller 100 is further arranged for deriving a concentration signal based on the received RF signal.

The dosing controller 100 is further arranged for calculating a dose of the above mentioned additive. The calculation is based on the derived concentration signal. Advantageously, the calculation is also based on the Critical Process Indicator input signal(s).

The dosing controller 100 is further arranged for supplying a dosing signal to the dosing device 160, causing the dosing device 160 to add the calculated dose of the additive at the dosing location 182 in the sewer network.

The system in FIG. 1 further comprises a main controller 400, which is operatively connected to the dosing controller 100 via a communication network 410. The communication network may advantageously be based on TCP/IP protocol and wired and/or wireless technologies including Ethernet, WiFi, GSM/GPRS and RE relays.

As illustrated, further dosing controllers, indicated at 100A, 100B, . . . , 100N, may also be included in an extended version of the system. Each dosing controller 100A, 100B, . . . , 100N is operatively connected to the main controller 400 via the network 410, or alternatively, by means of a separate communication channel. Each dosing controller 100A, 100B, . . . , 100N is arranged in the same way as the dosing controller 100 described above, in order to control the dosing of an additive at an associated dosing location in the extended sewer network. Each dosing controller 100A, 100B, . . . , 100N will be arranged to receive at least a radio frequency signal from a corresponding monitoring device, e.g. identical to the monitoring device 200 described above. Each dosing controller 100A, 100B, . . . , 100N will advantageously also be arranged to receive signals from corresponding CPI input devices.

The main controller 400 is arranged to take into account physical and biological sewer network parameters, and empirical and theoretical models to coordinate the overall balance of chemical dosing. It coordinates all the data accordingly to calculate the required dose at any given point in the sewer network at any given time.

An embodiment of the system which comprises a main controller 400 and a plurality of dosing controllers 100A, 100B, . . . , 100N results in a distributed control network, wherein the dosing controllers may be regarded as subsidiary controllers which are overseen by the central coordinating main controller 400.

The main controller 400 and the dosing controllers 100A, 100B, . . . , 100N all have the capability to operate independently should parts of the network 410 fail.

In the event of a dosing controller failing,. the main controller 400 is arranged to compensate by redistributing the dosing to the remaining dosing controllers 100A, 100B, . . . 100N.

The dosing controllers 100A, 100B, . . . , 100N perform control calculations locally before measurements are relayed to the main controller. This reduces the processing load on the main controller.

A master and slave configuration is used in a distributed system with a main controller 400 and the dosing controllers 100A, 100B, . . . , 100N. The main controller 400 is configured as master, the dosing controllers are configured as slaves. In both types of controllers, master and slave, an individual written script control the outputs (dosing signal) as result of the process parameters and a chosen control method. A slave just takes those process parameters into account that are connected to this particular unit. The master additionally computes information from all the slaves and can control all outputs on all slaves with the highest priority.

FIG. 2 is a schematic block diagram illustrating some elements of the system shown in FIG. 1 in closer detail. In particular, FIG. 2 illustrates further structural details of the monitoring device 200 and the dosing controller 100.

The monitoring device 200 is a processor-based electronic device, comprising an internal bus 210 which interconnects a processor 230, a memory 220, an input adapter 240 and an RP transmitter 250. The input adapter 240 is connected to the H₂S sensor 260 for providing the measured H₂S concentration.

The monitoring device 200 further comprises a battery (not shown) and an encapsulation (not shown). The encapsulation is advantageously humidity resistant. The monitoring device 200 is advantageously designed in order to fulfill the requirements of Ex Zone 1 approval, in order to be safely placed underground in the manhole.

The battery and the characteristics of the monitoring device are dimensioned in order to provide a battery life of more than one year of regular operation. In order to reduce energy consumption and thus to increase battery life, the RF transmission is time controlled.

The H₂S sensor 260 advantageously provides an analog signal, such as a voltage signal, proportional to the H₂S concentration. Advantageously, the voltage signal is in the mV range. As an example, the voltage signal may be in the range 0-2V.

The voltage signal is converted to a digital signal by the input adapter 240 and stored and processed in the memory 220 of the monitoring device 200.

The power consumption of the sensor 260 is advantageously low, e.g. about 300 μW. Since the sensor has a warm up time, and in order to increase accuracy, the sensor will advantageously be powered continuously. Alternatively, the sensor 260 may be enabled and disabled by time control in order to further reduce long term power consumption.

The digitized measurements are supplied to the RF transmitter 250, which transmits an FM signal by means of an antenna Typically, a licence free band such as an IMS band is used, typically in the 900 MHz range. Other frequencies can also be used, depending on the required RF range and performance.

The RF transmitter 250 is activated at regular time intervals or whenever the input signal has changed. Advantageously, the threshold for trigging transmission by the transmitter 250 is adjustable.

When the signal is transmitted at regular intervals, the interval between transmissions can be set by configuration data held in the memory 220. The interval may be a few seconds, about one minute, several minutes or even an hour or several hours, depending on the circumstances. A balance may thus be established between long time between transmissions, leading-to low power consumption, and the wish of high resolution data.

Advantageously, each RF signal transmission is repeated two, three or even more times in order to increase transmission reliability.

Further with reference to FIG. 2, the dosing controller 100 is also a processor-based electronic device, comprising an internal bus 110 which interconnects a processor 130, a memory 120, an output adapter 140 and an RF receiver 150. The output adapter 140 is connected to the dosing device 160.

The RF receiver 150 is arranged for converting the received RF signal into a digital signal which is fed to the bus 110.

The output adapter 140 is arranged for providing an analogue output signal that easily can be feed into one of the analogue inputs of the dosing device 160. Advantageously, an industrial standard 4-20 mA output signal is provided by the output adapter 140. Advantageously, the analogue output signal is held at a stable level until the next transmission is received by the receiver 150.

The use of a standard 420 mA current signal usually implies relatively high power consumption. Since power is generally available at the dosing location 182, the use of a standard 4-20 mA current signal is not a problem at this location.

The additive supply 170 is a storage reservoir or tank. The shape and size of the supply 170 may be selected by the skilled person depending on aspects such as expected consumption of the additive and the physical location. The size may typically vary from 1 m³ to 20 m³. When required the supply 170 is equipped with means for keeping a constant pressure load on the dosing device to ensure correct dosing. It is also advantageously equipped with at least one level sensor in order to provide signals for product supply as well as for process control (e.g., checking calibration and real dosing).

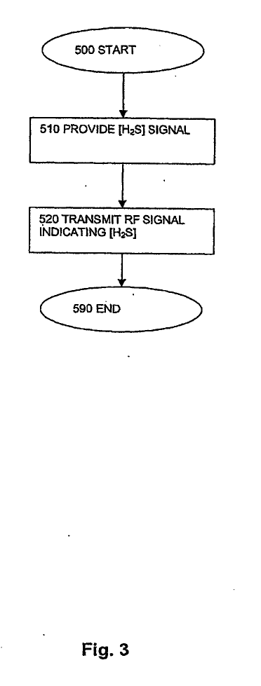

FIG. 3 is an exemplary flow chart illustrating process steps performed by a monitoring device in accordance with the invention.

The process starts at the initiating step 500.

Next, in step 510 a signal indicating the measured H₂S concentration is provided by the sensor 260.

Next, in step 520, an RF signal which carries information representing said measured H₂S concentration is transmitted by the RF transmitter 250. The process ends at step 590. Typically, the process will be reiterated. Further details of this process will be recognized from the detailed description of the monitoring device 200 above.

In operation, the memory 220 in the monitoring device 200 contains a computer program portion with processor instructions which causes the processor 230 to put into effect the steps of-the process illustrated in FIG. 3 and described above.

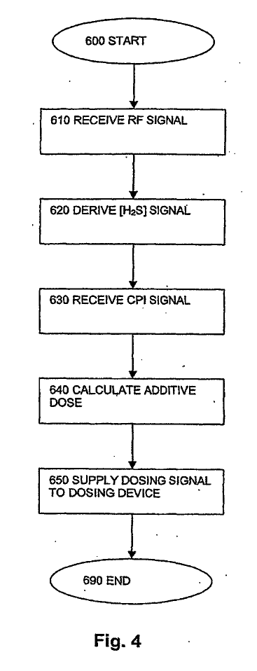

FIG. 4 is an exemplary flow chart illustrating process steps performed by a dosing controller in accordance with the invention.

The process starts at the initiating step 600.

Next, in step 610, a RF signal is received. In the system, the received RF signal will be an RF signal transmitted by a monitoring device 200, possibly via at least one repeater 310, as explained above.

Next, in step 620, a H₂S concentration signal is derived, based on the received RF signal.

Next, in step 630, at least one critical process indicator (CPI) signal is received from the CPI input device 190 by the input adapter 180.

The CPI input signal comprises at least one of a flow measurement signal, a temperature measurement signal, a sewage pump operation, signal, and a water quality signal. Any of these signals are advantageously acquired at the dosing location 182.

Next, in step 640, a dose of the above mentioned additive is calculated, based the derived H₂S concentration signal. Advantageously, the calculation is also based on the received CPI signal(s), i.e. critical process indicators measured at the dosing location 182.

The step 640 of calculating the additive dose takes into account both dynamic and static information. The dynamic information includes H₂S concentration measured at the monitoring location 270, critical process indicators acquired at the dosing location 182, and information on time and date. The static information includes sewer network characteristics and number and size of sewage pumps in the system.

The calculating step 640 advantageously includes subprocesses that take into account biological and hydraulic conditions. Because of the complexity of sewer networks, variations in flow patterns and quality and the plug flow regime, the calculating step 640 performed by the dosing controller 100 uses historical data together with real-time data to be able to give a good prediction of the dose.

The actual optimal dose depends to some extent on the conditions in water flow and quality following the next hours.

The signal acquired from the monitoring location, which indicates the concentration of the detrimental substance measured at the monitoring location, is advantageously used in the calculating step 640 to establish a set of historical data that are used in the calculating of an additive dose. Such historical data are very valuable because they show the results of the dosing.

The signal acquired from the monitoring location may also be used as a direct response for adjustment of dose (standard feedback). In this case, a regular feedback control method is employed in the calculating step 640, such as PI or PID type control method. This approach is particularly useful when the retention time between dosing and critical control point is limited to a few hours (in practice less than 1-2 hours, or in cases where the event is longer than the retention time. Since sewer systems are plug flow systems, the signals from the monitoring location is time shifted according to the retention time (e.g. with 3 hours retention time, an incorrect dose around 12:00 will be monitored downstream around 15:00).

Advantageously, the system in particular the calculating step 640 performed by the dosing controller 100, includes a self-learning function where the dose at the same time the following day is adjusted based on the monitored data with adjustments for changes in retention time and water quality.

The system, in particular the calculating step 640 performed by the dosing controller 100, is also advantageously arranged to compare data back in time and fine-tune the dose based on the actual conditions and adjustments in the past. The steps performed by the dosing controller advantageously comprises continuous or repeated iterations for best possible prediction of retention time based on actual flow data and historical flow data from the day before, the same day the previous week or from historical data that are most similar to the actual data. Data are registered by time, date and day of week, and are logged over years in order to find repetitive patterns on dosing required.

Next, in step 650, a dosing signal is supplied to the dosing device 160. The dosing signal represents the calculated dose in such a way that the dosing device 160 will add the calculated dose of the additive at the dosing location 182 in the sewer network.

The process ends at step 690. Typically, the process will be reiterated. Further details of this process will be recognized from the detailed description of the dosing controller 100 above.

In operation, the memory 120 in the dosing controller 100 contains a computer program portion with processor instructions which causes the processor 130 to put into effect the steps of the process illustrated in FIG. 4.

Modifications and adaptations of the invention will be apparent to those skilled in the art from consideration of the specification and practice of the invention as disclosed. The above description of a preferred embodiment of the invention has been presented for purposes of illustration and description. It is not exhaustive and does not limit the scope of the invention to the precise form disclosed. Modifications and variations are possible in light of the above teachings or may be acquired from the practicing of the invention. Certain modifications and variations within the scope of the invention are also expected to appear as the technology advances.

1-18. (canceled)

19. System for controlling the concentration of a detrimental substance in a sewer network, comprising:
a monitoring device (200), arranged for
providing a signal indicating a measured concentration of said detrimental substance at a monitoring location (270) in said sewer network, and
transmitting a signal carrying information about said concentration, and a dosing controller (100), arranged for
receiving said signal carrying information about said concentration,
deriving a concentration signal based on said received signal,
calculating a dose of an additive based on said derived concentration signal, said additive being selected in order to counterbalance the effect of the detrimental substance, and
supplying a dosing signal to a dosing device (160), causing the dosing device (160) to add said calculated dose at a dosing location (182) in said sewer network, wherein
said monitoring device comprises a time controlled radio frequency transmitter adapted to transmit said signal carrying information about said concentration as a radio frequency signal, the radio frequency transmitter being activated
at regular time intervals or
whenever the concentration indicating signal has changed, with an adjustable threshold for trigging transmission.

20. System according to claim 19, wherein said dosing controller is further arranged to calculate said dose of said additive based on a critical process indicator measured at the dosing location (182).

21. System according to claim 20, wherein said critical process indicator is included in the following group of signals: a flow measurement signal, a temperature measurement signal, a sewage pump operation signal, and a water quality signal.

22. System according to claim 19, wherein
said dosing location (182) is at an upstream point in a sewer conduit with respect to said monitoring location (270).

23. System according to claim 19, wherein
said monitoring location (270) comprises a manhole in said sewer network.

24. System according to claim 19, wherein
said detrimental substance is a reduced organic substance.

25. System according to claim 24, wherein
said detrimental substance is a reduced sulphuric compound.

26. System according to claim 25, wherein
said detrimental substance H₂S, and
said additive is a nitrate-based H₂S controlling substance.

27. System according to claim 19, wherein said monitoring device (200) comprises:
an internal bus (210), interconnecting
a processor (230), a memory (220), an input adapter (240) and an RF transmitter (250),
said input adapter (240) being connected to a sensor (260) for providing said measured concentration.

28. System according to claim 19, wherein said dosing controller (100) comprises:
an internal bus (110), interconnecting
a processor (130), a memory (120), an output adapter (140) and an RF receiver (150), said output adapter (140) being connected to said dosing device (160).

29. System according to claim 28, wherein said dosing controller further comprises:
an input adapter (180) connected to a critical process indicator input device (190) at the dosing location, said input device being selected from a group comprising a flow meter, a temperature sensor, a sewage pump control system, and a water quality sensor.

30. System according to claim 19,
further comprising a radio frequency repeater (310) arranged above ground between said monitoring device (200) and said dosing controller (100).

31. System according to claim 19,
further comprising a main controller (400), operatively connected to said dosing controller (100) via a communication network (410), said main controller being arranged to perform at least one of the following steps:
coordinating the overall balance of chemical dosing in the sewer network, and
in the event of a failure in a dosing controller, to re-distribute the control task of the failed dosing controller to another dosing controller.

32. System according to claim 19, wherein said dosing controller (100) is arranged for calculating said dose of said additive based on said derived concentration signal by means of a regular feedback control method, such as a PI or PID control method.

33. System according to claim 32,
wherein said dosing controller (100) is further arranged for calculating said dose of said additive based on historical concentration signal data, including concentration signal values measured at the same time on a previous day.

34. A dosing controller (100) for use in a system for controlling the concentration of a detrimental substance in a sewer network, the system comprising a monitoring device (200), arranged for
providing a signal indicating a measured concentration of said detrimental substance at a monitoring location (270) in said sewer network, and
transmitting a signal carrying information about said concentration, the dosing controller (100) being arranged for
receiving said signal carrying information about said concentration,
deriving a concentration signal based on said received signal,
calculating a dose of an additive based on said derived concentration signal, said additive being selected in order to counterbalance the effect of the detrimental substance, and
supplying a dosing signal to a dosing device (160), causing the dosing device (160) to add said calculated dose at a dosing location (182) in said sewer network, wherein
said monitoring device comprises a time controlled radio frequency transmitter adapted to transmit said signal carrying information about said concentration as a radio frequency signal, the radio frequency transmitter being activated
at regular time intervals or
whenever the concentration indicating signal has changed, with an adjustable threshold for trigging transmission.

35. Dosing controller according to claim 34,
the dosing controller (100) being further arranged for calculating said dose of said additive based on said derived concentration signal by means of a regular feedback control method, such as a PI or PID control method.

36. Dosing controller according to claim 35,
the dosing controller (100) being further arranged for calculating said dose of said additive based on historical concentration signal data, including concentration signal values measured at the same time on a previous day.
